(19) United States
(12) Patent Application Publication
(10) Pub. No.: US 2013/0033031 A1
(43) Pub. Date: Feb. 7, 2013

(54) Rotating Label Warning System For A Container

(71) Applicant: Stephen M. Key, Modesto, CA (US)

(72) Inventor: Stephen M. Key, Modesto, CA (US)

(21) Appl. No.: 13/564,689

(22) Filed: Aug. 1, 2012

Related U.S. Application Data
(60) Provisional application No. 61/514,362, filed on Aug. 2, 2011.

(51) Int. Cl. B42D 15/00

(52) U.S. Cl. 283/67; 283/81

(57) ABSTRACT

The present application is directed to systems and methods for delivering warnings and instructions for a container. A base label may be adhered to the container, and at least a first, a second, and a third visual representation of a warning or instruction is displayed on the base label. A top label may cover at least a portion of the base label. The top label may be rotatable about the base label. The top label may have a transparent window allowing at least one of the first, second, or third visual representations to be visible through the transparent window.

### CROSS-REFERENCE TO RELATED APPLICATIONS

The present application claims priority to provisional U.S. Patent Application Ser. No. 61/514,362, filed on Aug. 2, 2011, titled “Rotating Label to Visually Represent and Alert to Drug Interactions, Warnings and Instruction,” which is hereby incorporated by reference in its entirety.

### FIELD OF THE INVENTION

The present application is directed generally to labels, and more specifically to labels for consumer product containers that function as a drug interaction and warning instruction delivery system.

### BACKGROUND

Containers for consumer products have a limited amount of outer surface area for placement of labels on the container. This may pose a challenge to manufacturers of these consumer products to fit all of the information they want to deliver to the consumer, or are required by law to deliver to the consumer, in this limited area. In particular, prescription medication manufacturers may desire to deliver expanded information on interactions with other drugs, warnings associated with use of the medication, or other important information or instructions for the consumer.

More than three billion prescriptions are written each year in the United States, and an estimated $18 billion is spent on over-the-counter medications. For many individuals, treatment of illnesses requires the consumption of several medications. The average number of pills taken daily by individuals over the age of 60 is seven. With this volume of medications consumed comes the risk of drug interactions. Drug interactions may be defined as a reaction between a medication and another substance that affects the activity of the drug or produces a new effect that may not occur with the medication alone. Interactions may occur between two or more medications, or may occur between a medication and a food or beverage. Consumption of two or more substances that interact may occur from accidental misuse or from a lack of knowledge about the active ingredients in the substances. Confusion over interpretation of warning label information, illiteracy, and vision problems may exacerbate the situation.

### SUMMARY

The present application is directed to warning and instruction delivery systems for a container. An exemplary warning and instruction delivery system may comprise a base label adhered to the container. The base label may have a back surface and a front surface, with at least a first, a second, and a third visual representation of a warning or instruction on the front surface. The warning and instruction delivery system may further comprise a top label covering at least a portion of the front surface of the base label. The top label may be rotatable about the base label. In various embodiments, the top label may have a transparent window allowing at least one of the first, second, or third visual representations to be visible through the transparent window.

According to additional exemplary embodiments, the present application may be directed to methods for delivering warnings or instructions associated with a container. An exemplary method may comprise adhering a base label having a back surface and a front surface to the container, and displaying at least a first, a second, and a third visual representation of a warning or instruction on the front surface of the base label. At least a portion of the front surface of the base label may be covered by a rotating top label. A transparent window may be placed within the rotating top label, such that at least one of the first, second, or third visual representations may be visible through the transparent window.

### BRIEF DESCRIPTION OF THE DRAWINGS

FIG. 1 is a front view of an exemplary label according to various embodiments.

FIG. 2 is a back view of an exemplary label according to various embodiments.

FIG. 3 is a front view of an exemplary label according to various embodiments.

FIG. 4 is a back view of an exemplary label according to various embodiments.

FIG. 5A illustrates a leading edge of an exemplary label affixed to a container according to various embodiments.

FIG. 5B illustrates an exemplary label secured about a container according to various embodiments.

FIG. 6 illustrates an exemplary label secured about a container according to various embodiments.

FIG. 7 illustrates an exemplary base label secured about a container according to various embodiments.

FIG. 8 illustrates a leading edge of an exemplary top label affixed to an exemplary base label according to various embodiments.

FIG. 9 illustrates an exemplary top label affixed to an exemplary base label and partially wrapped about a container according to various embodiments.

FIG. 10 illustrates an exemplary top label with a window affixed to an exemplary base label and partially wrapped about a container according to various embodiments.

FIG. 11 illustrates an exemplary top label with a window secured about a container and a portion of a base label visible through the window according to various embodiments.

FIG. 12 is a front view of a base label according to various embodiments.

FIG. 13 is a front view of a top label according to various embodiments.

FIG. 14 illustrates an exemplary base label secured about a container according to various embodiments.

FIG. 15A illustrates an exemplary base label and top label secured about a container according to various embodiments.

FIG. 15B illustrates an exemplary base label and top label secured about a container according to various embodiments.

FIG. 15C illustrates an exemplary base label and top label secured about a container according to various embodiments.

FIG. 16 illustrates an exemplary base label according to various embodiments

FIG. 17 is an exemplary flow diagram of a method for delivering warnings or instructions associated with a container according to various embodiments.

### DETAILED DESCRIPTION

The present application is directed to warning and instruction delivery systems for a container and methods delivering warnings and instructions associated with a container. An exemplary warning and instruction delivery system may comprise a base label adhered to the container. The base label may have a back surface and a front surface, with at least a first, a second, and a third visual representation of a warning or instruction on the front surface. The information delivery system may further comprise a top label covering at least a portion of the front surface of the base label. The top label may be rotatable about the base label. In various embodiments, the top label may have a transparent window allowing at least one of the first, second, or third visual representations to be visible through the transparent window.

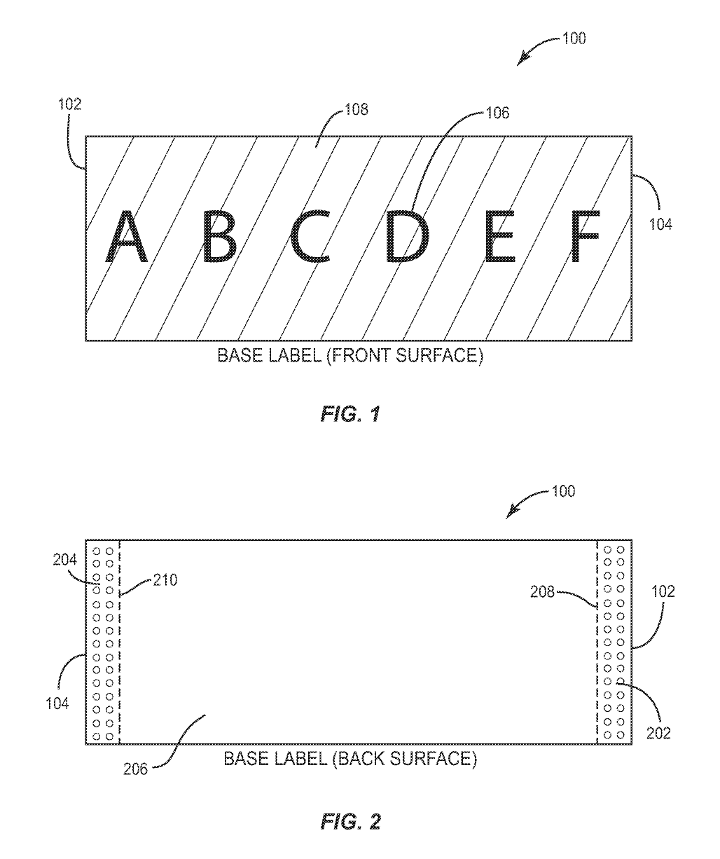

FIG. 1 illustrates various embodiments of a front surface 108 of a base label 100 for an object, such as a medication container, according to various embodiments. The base label 100 comprises a leading edge 102 and a trailing edge 104. While the leading edge 102 is oriented to the left and the trailing edge is oriented to the right as presented in FIG. 1, the orientation of the leading edge 102 and the trailing edge 104 could be reversed depending on which edge is first applied to the object. Both orientations are within the scope of the present disclosure. Base label front surface 108 may comprise writing or other indicia 106 thereon.

As used herein, the leading edge refers to the first edge to be affixed to the object and the trailing edge refers to the second edge to be affixed to the object or the overlapping leading edge. Depending on the orientation of the label and the object when the label is affixed to the object, either edge of the label may be the leading edge. The orientations presented in the figures are for convenience and are not intended to be limiting in any way.

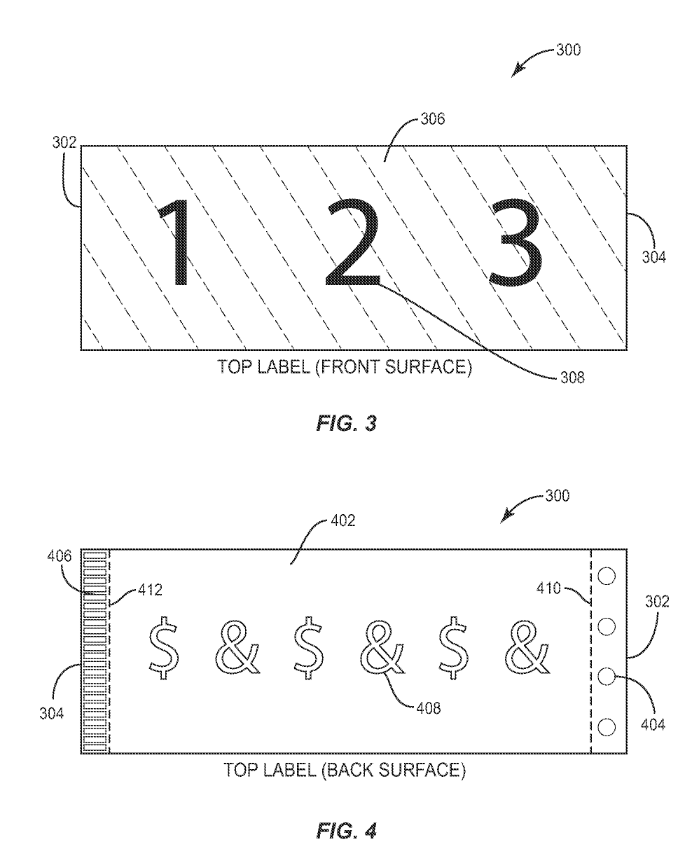

FIG. 2 illustrates various embodiments of a back surface 206 of the base label 100. In various embodiments, the base label back surface 206 comprises two strips of adhesive 202 and 204 on or immediately adjacent to the leading and trailing edges, 102 and 104, respectively. Base label leading edge adhesive 202 may have a boundary 208 defined as its limit on the base label back surface 206. Base label trailing edge adhesive 204 may also have a boundary 210. While FIG. 2 illustrates that the adhesive strips 202 and 204 are generally close to the base label leading and trailing edges 102 and 104, respectively, it is understood that the adhesive strips 202 and 204 may be continuous or discontinuous, and may extend across any portion of the base label back surface 206, including the entire base label back surface 206. In various embodiments, a length of the base label 100 may be selected to be slightly longer than a circumference of the object on which it is placed, such that the trailing edge 104 overlaps the leading edge 102, and the trailing edge 104 is affixed to the leading edge 102. In various embodiments, the length of the base label 100 may be selected to be approximately the same as the circumference of the object on which it is placed, such that the leading edge 102 and the trailing edge 104 do not overlap.

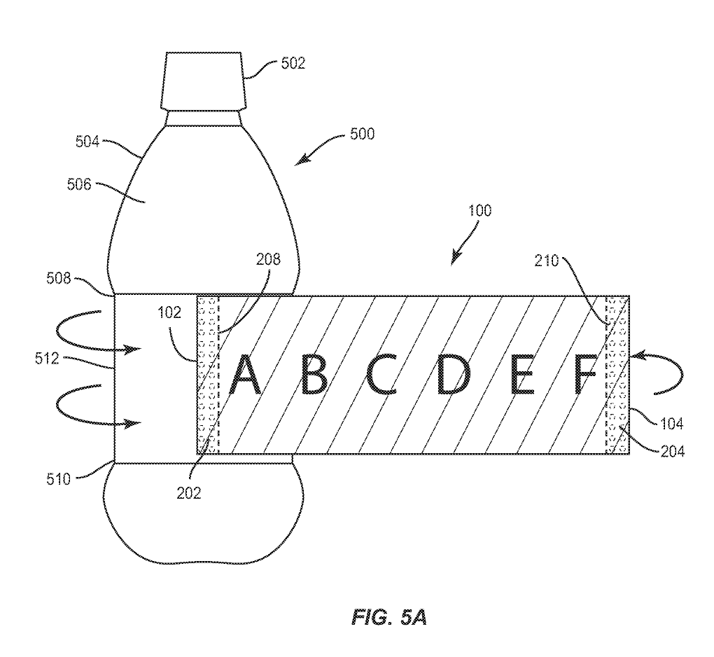

FIG. 3 illustrates various embodiments of a front surface 306 of a top label 300. Top label 300 comprises a leading edge 302 and a trailing edge 304, and indicia 308 may be imprinted on the top label front surface 306.

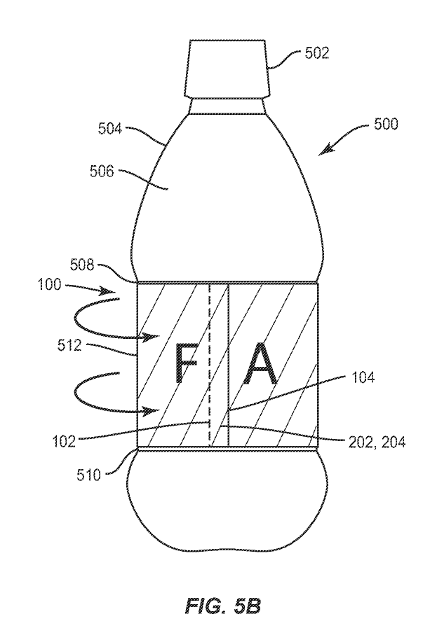

Various embodiments of a back surface 402 of the top label 300 are illustrated in FIG. 4. The top label back surface 402 may comprise various indicia 408 printed thereon, as well as two strips of adhesive 404 and 406 on or immediately adjacent to the leading and trailing edges, 302 and 304, respectively. Top label leading edge adhesive 404 may have a boundary 410 defined as its limit on the top label back surface 402. Top label trailing edge adhesive 406 may also have a boundary 412. While FIG. 4 illustrates that the adhesive strips 404 and 406 are generally close to the top label leading and trailing edges 302 and 304, respectively, it is understood that the adhesive strips 404 and 406 may be continuous or discontinuous, and may extend across any portion of the top label back surface 402, including the entire top label back surface 402. In various embodiments, the adhesive strips 404 and 406 are confined to areas near the leading and trailing edges 302 and 304, respectively, so as not to obscure or interfere with the top label back surface indicia 408.

The base label adhesive 202, 204 and the top label adhesive 404, 406 may be applied in a variety of patterns as can be appreciated by one skilled in the art. The adhesive 202, 204, 404, 406 may be applied in in strips, dots, droplets, circles, rectangles, squares, triangles, lines, and the like, as well as combinations of patterns.

A length of the top label 300 may be selected to be slightly longer than a circumference of the object on which it is placed, such that the top label trailing edge 304 overlaps the top label leading edge 302, and the top label trailing edge 304 is affixed to the top label leading edge 302. In various embodiments, the length of the top label 300 may be selected to be approximately the same as the circumference of the object on which it is placed, such that both the leading edge 302 and the trailing edge 304 do not overlap and are affixed to the base label front surface 108.

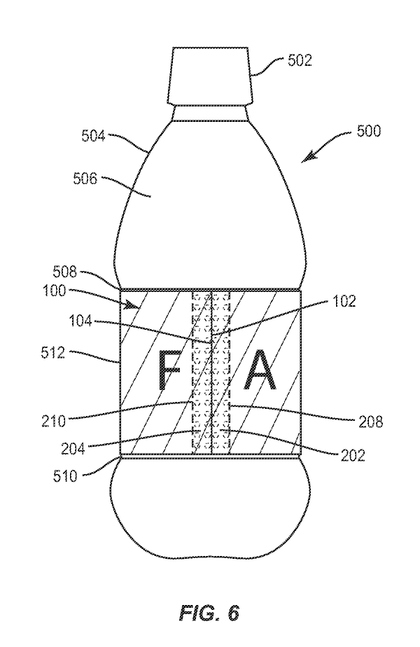

FIG. 5A illustrates the application of the base label 100 to an exemplary container 500 according to various embodiments. The container 500 may be a glass or plastic bottle, or other type of container such as a metal can or a cardboard receptacle. The container may be round, rectangular, square, or any other shape known in the art. The term “container” is used here for convenience to describe exemplary embodiments. It is understood that the container may be any object, including non-containers. Container 500 may comprise a cap 502 removably secured to a body 504. Various embodiments of the body 504 may have an exterior surface 506 that comprises a upper label panel 508, a lower label panel 510, and a recessed surface 512 interposed between the upper label panel 508 and the lower label panel 510. As discussed below, the base label 100 may be applied to the container 500 at the recessed area 512 between the upper label panel 508 and the lower label panel 510.

In various embodiments, the top label 300 may be rotatable about the base label 100, as discussed below. In these embodiments, the upper label panel 508 and lower label panel 510 may function to restrict upward and downward movement of the top label 300 in relation to the container 500 such that the top label 300 generally remains in a position covering at least a portion of the base label 100.

FIG. 5B illustrates the container 500 with the base label 100 affixed to the container 500. Initially, as illustrated in FIG. 5A, base label leading edge 102 is placed in contact with the recessed surface 512 of the container 500 and affixed to the container 500 by the leading edge adhesive strip 202. With relative motion between the container 500 and the base label 100, the base label 100 may be wrapped around the container 500 with the base label trailing edge 104 now overlapping the base label leading edge 102 such that the leading edge adhesive strip 202 holds the base label leading edge 102 to the container 500 while the trailing edge adhesive strip 204 holds the base label trailing edge 104 to the overlapped base label leading edge 102.

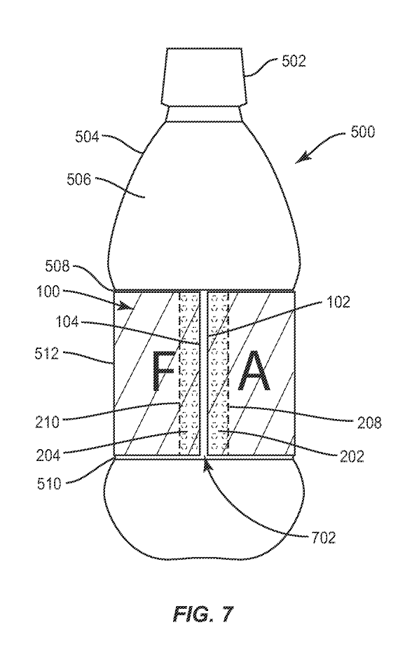

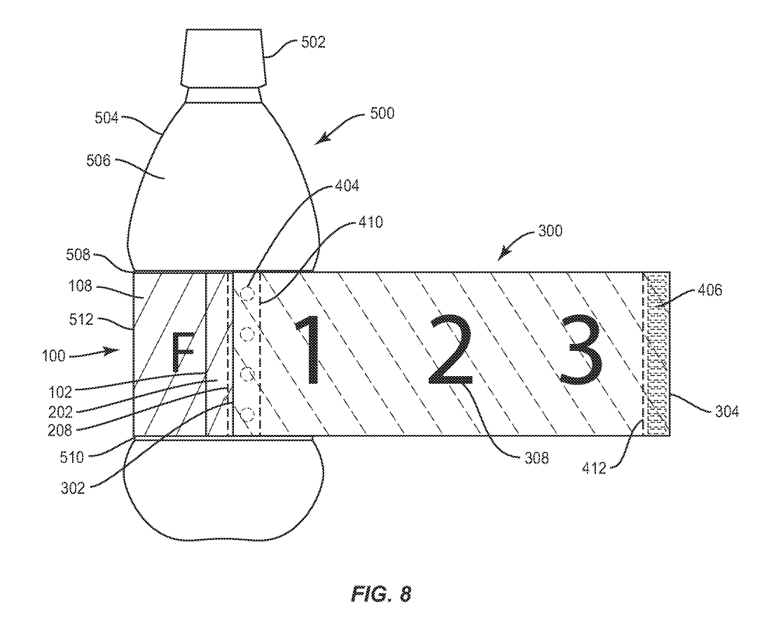

In various embodiments as illustrated in FIG. 6, the length of the base label 100 may be substantially the same as a circumference of the recessed surface 512 of the container 500, which may allow the base label leading edge 102 and base label trailing edge 104 to abut rather than overlap. However, it is also possible that the length of the base label 100 may be shorter than the circumference of the recessed surface 512, resulting in a gap 702 between the base label leading edge 102 and the base label trailing edge 104 when the base label 100 is affixed to the recessed surface as illustrated in FIG. 7. In both of these instances, the base label trailing edge adhesive strip 204 may adhere to the recessed surface 512 of the container 500, rather than the base label leading edge 102.

In various embodiments, the base label adhesive strips 202, 204 may comprise a permanent adhesive. In general, a permanent adhesive is one that does not readily release from a surface to which it adheres after the adhesive dries or cures. Using the base label 100 as an example, the permanent adhesive 202, 204 will tend not to release from the recessed surface 512, nor will it tend to release the base label leading edge 102 or trailing edge 104 once dried or cured. In order to remove the base label from the recessed surface 512, the base label 100 may have to be torn from the adhesive, or the adhesive layer 202, 204 may have to be fractured which may leave some of the adhesive on the recessed surface 512 and some of the adhesive on the base label leading edge 102 or trailing edge 104. Once the surfaces affixed with the permanent adhesive are separated, they may not be reattached.

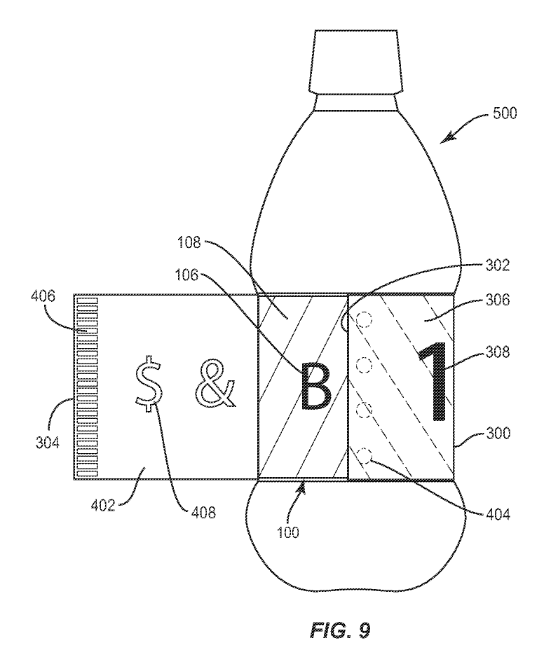

In FIG. 8, the base label 100 is already affixed to the recessed surface 512 of the container 500, and the application of the top label 300 over the base label 100 is illustrated according to various embodiments. The top label leading edge 302 may be placed in contact with any portion of the base label front surface 108 and affixed to the base label front surface 108 by the top label leading edge adhesive strip 404. With relative motion between the container 500 and the top label 300, the top label 300 may be wrapped around the container 500 with the top label trailing edge 304 now overlapping the top label leading edge 302 such that the top label leading edge adhesive strip 404 holds the top label leading edge 302 to the base label 100 while the top label trailing edge adhesive strip 406 holds the top label trailing edge 304 to the overlapped top label leading edge 302.

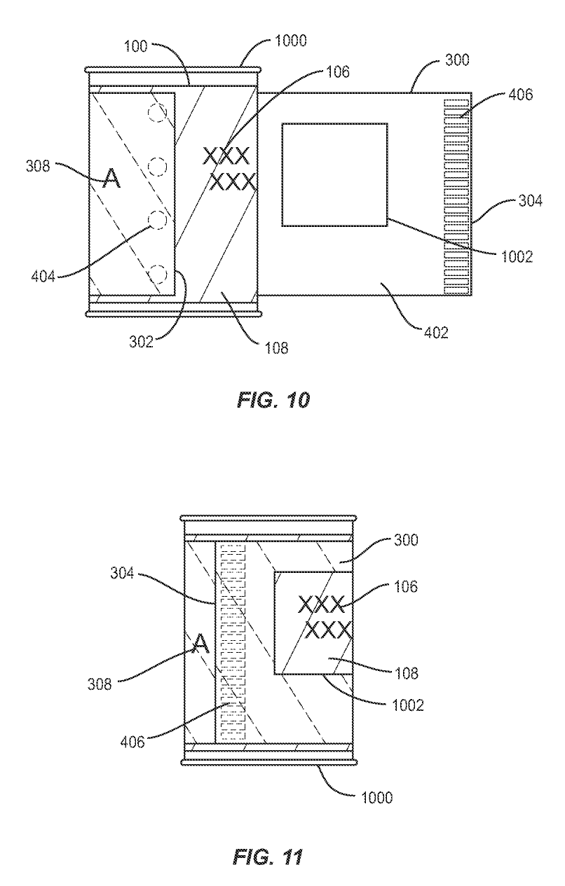

FIG. 9 illustrates the operation of the base label 100 and the top label 300 according to various embodiments. Beginning with the container 500 with the base label 100 and the top label 300 in place as shown, for example, in FIG. 6, the top label trailing edge 304 may be detached from the top label leading edge 302 and at least partially peeled back as shown in FIG. 9. The combination of the base label 100 and the top label 300 in this configuration increases the amount of surface area available for viewing by a consumer or user of the container 500. Prior to detaching the top label trailing edge 304, the consumer may view the top label front surface 306. Upon detaching the top label trailing edge 304, the consumer may now view the top label back surface 402 and the base label front surface 108 in addition to the top label front surface 306.

One of at least three types of adhesive may be used for the top label leading edge adhesive 404. A first type of adhesive is the permanent adhesive as described above for the base label 100. When a permanent adhesive is used for the top label leading edge adhesive 404, the top label leading edge generally cannot be detached without inflicting damage to one or both of the top label 300 or the base label 100. This may be desirable for various embodiments where the top label 300 is not intended to be removed from the container 500.

A second type of adhesive that may be used for the top label leading edge adhesive 404 is a releasable adhesive. A releasable adhesive is one that will release from a surface to which it is attached once a sufficient mechanical force is applied. A releasable adhesive may be used, for example, when the top label back surface 402 comprises a coupon for a subsequent purchase of a product. The releasable adhesive may allow the consumer to easily remove the top label 300 for later use. In various embodiments, the releasable adhesive may be a breakaway adhesive. A breakaway adhesive may have limited ability to withstand shear stresses. Shear stresses may cause the adhesive bond created between the label (e.g., top label 300) and the surface to which it is affixed (e.g., the base label 100 or container 500) to fail along the adhesive. In general, a releasable or breakaway adhesive may not re-attach to a surface once removed.

A third type of adhesive that may be used for the top label leading edge adhesive 404 is a resealable adhesive. A resealable adhesive may release from a surface to which it is attached once a sufficient mechanical force is applied, similar to the releasable adhesive described above. However, the resealable adhesive may be re-attached to a surface by applying pressure. A resealable adhesive may be desirable when the top label back surface 402 or the base label front surface 108 comprise information that may be needed only on occasion. Thus, the consumer or user may detach the top label 300 when the information is needed, then re-attach the top label 300.

In various embodiments, the top label trailing edge adhesive 406 may be a releasable adhesive or a resealable adhesive, depending on the intended use of the top label 300. As described above, if the surfaces 108, 402 comprise information that is intended to stay with the container, the top label trailing edge adhesive 406 may be a resealable adhesive. In contrast, if the top label 300 is intended to be removed from the container 500, a releasable adhesive may be desirable.

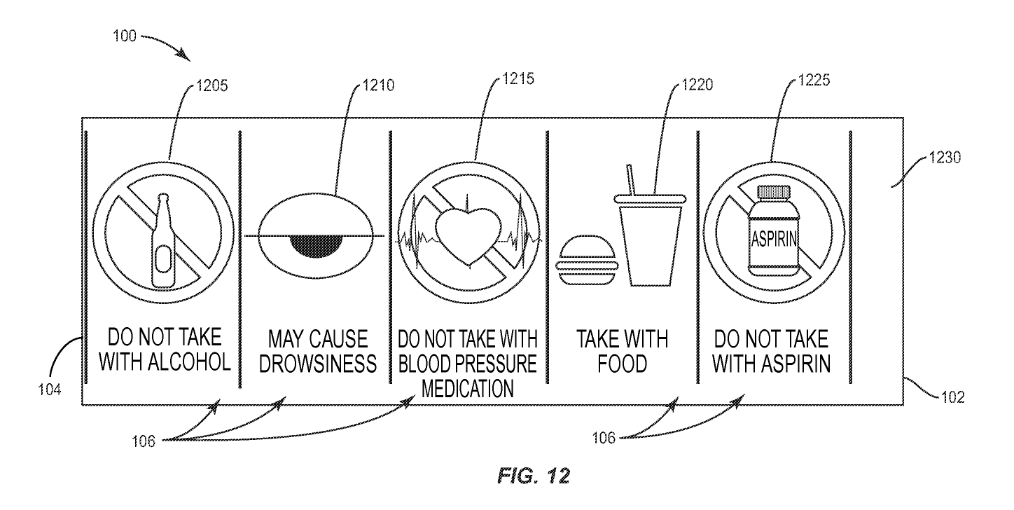

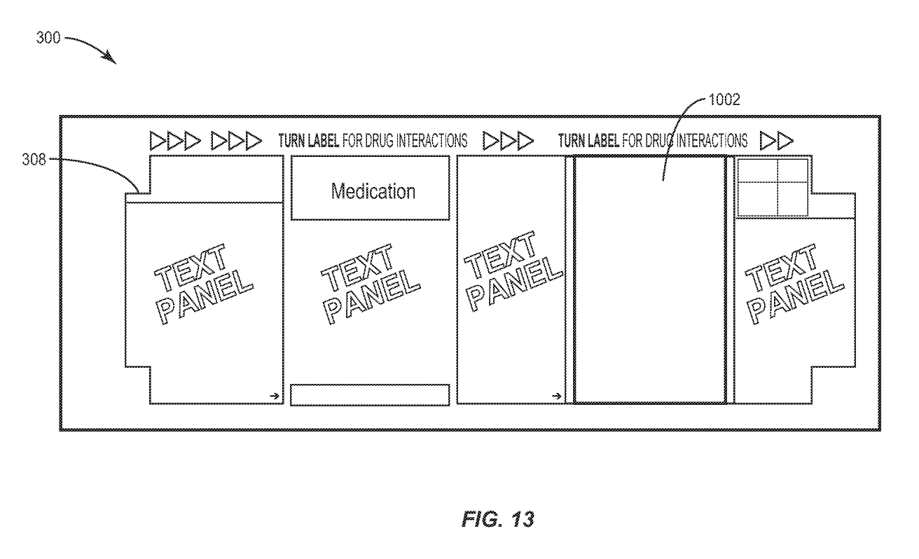

FIG. 10 illustrates various embodiments of the top label 300 comprising a window 1002. The window 1002 may comprise a void in the top label 300 such that a portion of the base label 100 may be visible through the window. In various embodiments, the window 1002 may have a transparent covering (not shown). In various other embodiments, the window may comprise a transparent section of the top label 300 itself rather than a void. FIG. 10 illustrates the top label 300 partially wrapped about a container 1000, and base label 100 already in place on the container 1000. As shown, the top label leading edge adhesive 404 maintains the top label 300 coupled to the base label 100. The top label 300 may then be moved from the position illustrated in FIG. 10 to the position illustrated in FIG. 11 to secure the top label 300 about the container 1000. Top label trailing edge adhesive 406 may couple to the top label leading edge 302 if the top label leading edge 302 and trailing edge 304 overlap; otherwise, the top label trailing edge adhesive 406 may be coupled to the base label front surface 108.

Once the top label 300 is in position on the container 1000 as illustrated in FIG. 11, at least a portion of the base label front surface indicia 106 may be visible through the window 1002. This may allow viewing of a first portion of the base label 100 without removing the top label 300. In various embodiments, the top label leading edge adhesive 404 may be a breakaway adhesive. Rotation of the top label 300 relative to the base label 100 may exert shear stresses on the breakaway adhesive, causing the adhesive bond affixing the top label leading edge 302 to the base label 100 to fail. The top label 300 may then be freely rotatable about the base label 100, and a second portion of the base label 100 may be visible when the top label 300 is rotated to a second position. The window 1002 may be rectangular as illustrated in FIGS. 10 and 11, or any other shape as needed for a particular application. For example, the window 1002 may be a slit that reveals an alphanumeric string on the base label 100. In various embodiments, the top label 300 may comprise more than one window 1002. Various embodiments in which the top label trailing edge adhesive 406 is a resealable or releasable adhesive may allow the top label 300 to be peeled back to reveal the top label back surface 402 and essentially the entire base label front surface 108 or to be removed from the container 1000, in addition to being rotatable.

One skilled in the art will readily recognize that labels may be applied to containers using a variety of methods and that there may be a variety of single-label and multi-label systems other than those described above. Any such application methods or label systems may be used with the present disclosure. The above descriptions are exemplary and not to be construed as limiting in any way. Examples of other application methods and label systems may be disclosed in U.S. Pat. Nos. 5,884,421, 6,086,697, 6,237,269, 6,402,872, 6,631,578, 6,649,007, 7,087,298, and 7,172,668.

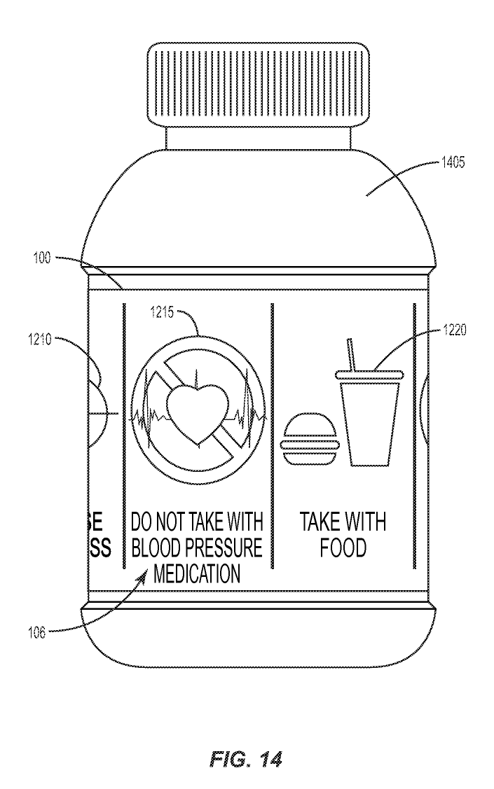

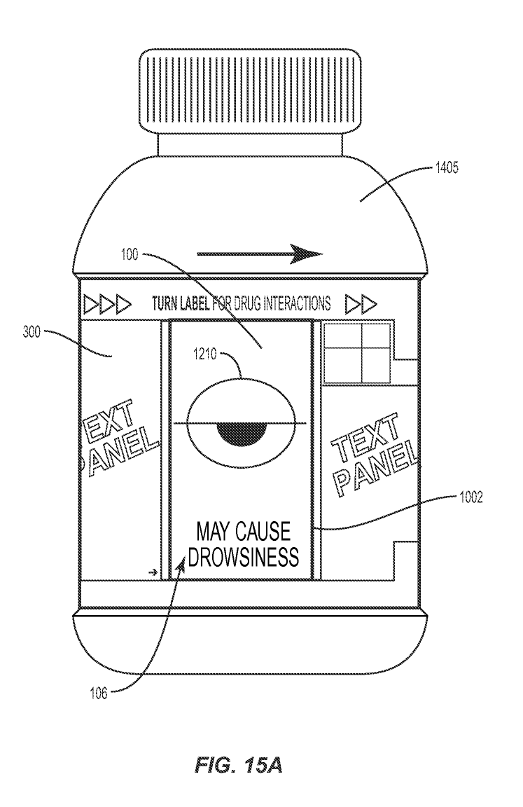

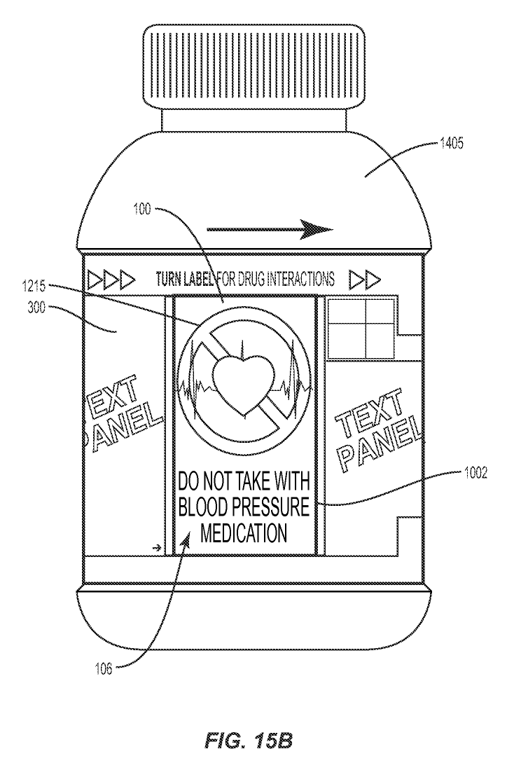

FIGS. 12 and 13 illustrate a base label 100 and top label 300, respectively, that may comprise an interaction and warning instruction delivery system for a container 1405 (see FIG. 14) according to various embodiments. The base label indicia 106 may comprise a plurality of individual interaction or warning instruction indicia 1205-1225. The top label 300 may comprise indicia 308 relaying product-related information, safety-related information, manufacturer-related information, and the like. In various embodiments, the top label may contain a transparent window 1002 as described previously (see FIG. 10).

The various embodiments of the base label 100 as illustrated in FIG. 12 may comprise a blank portion 1230 along the leading edge 102 that is essentially void of any base label indicia 106. As described previously, the trailing edge 104 may overlap the leading edge 102 when the base label 100 is applied to the container 1405. The blank portion 1230 may provide a space for attachment of the trailing edge 104 without obscuring any of the base label indicia 106.

In various embodiments, the instruction indicia 1205-1225 may comprise a plurality of pictograms or other graphical representations of the warning being conveyed that are easily identifiable visual representations of the warning or instruction. The pictogram may be quicker to identify than a written warning or instruction. For example, the pictogram may comprise a skull and crossbones to identify a poison, or may comprise a circle with diagonal bar to depict “no” or “do not.” Referring to FIG. 12, instruction indicia 1205, 1215, and 1225 convey warnings to not take with alcohol, to not take with blood pressure medication, and to not take with aspirin, respectively.

The pictograms may follow generally accepted standards such as international standard ISO 3864 or American standard ANSI Z535, or may comprise symbols or icons developed specifically for the substance in the container 1405 or the particular interaction or warning being conveyed. In addition to the pictogram, the instruction indicia 1205-1225 may comprise words or phrases to further explain the interaction, warning, or instruction in cases where the pictogram may have more than one possible interpretation or additional information is warranted. For example, instruction indicia 1220 may include the wording “TAKE WITH FOOD” to help clarify that the pictogram does not have a different meaning (such as do not take with food).

One skilled in the art will readily recognize that any combination of pictograms, icons, symbols, graphics, photographs, drawings, designs, and wording, either individually or in any combination or arrangement, are within the scope of the present disclosure. In addition, any color or combination of colors, backgrounds, and borders are within the scope of the present disclosure.

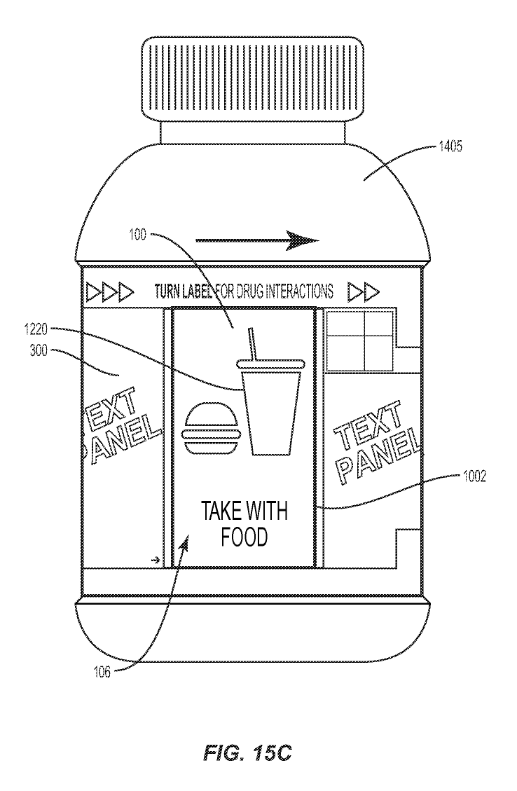

FIG. 14 illustrates the base label 100 positioned on the container 1405 according to various embodiments. As discussed above, the base label 100 may comprise instruction indicia 1205-1225 on the front surface such that the instruction indicia 1205-1225 at least partially encircle the container 1405. FIGS. 15A through 15C illustrate the top label 300 in place over the base label 100 on the container 1405 according to various embodiments. The base label 100 and the top label 300 may comprise an interaction and warning instruction delivery system that may be used, for example, on the medication container 1405 to provide additional functionality that may allow a consumer to obtain a wide variety of additional information about possible interactions, warnings, and instructions related to the product in the container 1405. Providing such dosage information may be advantageous to a consumer unfamiliar with how to dispense the medication, is not literate in the language of the label system, or may be visually impaired.

FIG. 15A illustrates the top label 300 in place over the base label 100. As described previously, the top label 300 may be applied such that the top label 300 is rotatable around a circumference of the container 1405. In FIG. 15A, the top label 300 has been rotated in the direction of the arrow revealing at least one of the instruction indicia 1205-1225 (in this example, instruction indicia 1210 corresponding to a warning for drowsiness) through the transparent window 1002 in the top label 300.

In various embodiments, the top label 300 may include instructions to aid the consumer in the use of the instruction indicia 1205-1225 visible in the transparent window 1002. For example, the top label 300 may comprise an instruction 15 such as “TURN LABEL FOR DRUG INTERACTIONS” as shown in FIG. 15A, or other similar instruction. The top label 300 may include more than one instruction as needed to inform the consumer of the use of the label system.

Similarly, FIGS. 15B and 15C illustrate the top label 300 further rotated in the direction of the arrow, thus revealing a different one of the instruction indicia 1205-1225 through the transparent window 1002. In the example of FIG. 15B, the top label 300 has been rotated until the instruction indicia 1215 for a blood pressure medication interaction warning is displayed in the transparent window 1002. Similarly, FIG. 15C illustrates the top label 300 rotated to show instruction indicia 1220 for an instruction to take the medication with food. Although FIGS. 15A-15C illustrate a single instruction indicia 1205-1225 visible through the transparent window 1002, two or more instruction indicia 1205-1225 may simultaneously be visible through the transparent window 1002 in various embodiments. Additionally, various embodiments may comprise more than one transparent window 1002 to display more than one instruction indicia 1205-1225 or other base label indicia 106.

According to various embodiments, the instruction indicia 1205-1225 may provide instructions for when the medication in the container 1405 is to be consumed. For example, the instruction indicia 1205-1225 may state that the medication is to be taken in the morning, at noon, and in the evening. The corresponding pictograms may comprise of a sun rising, a sun high above the horizon, and a moon. Similarly, the instruction indicia 1205-1225 may state that the medication is to be consumed on certain days of the week, and the corresponding pictograms may comprise a calendar with the proper days of the week highlighted.

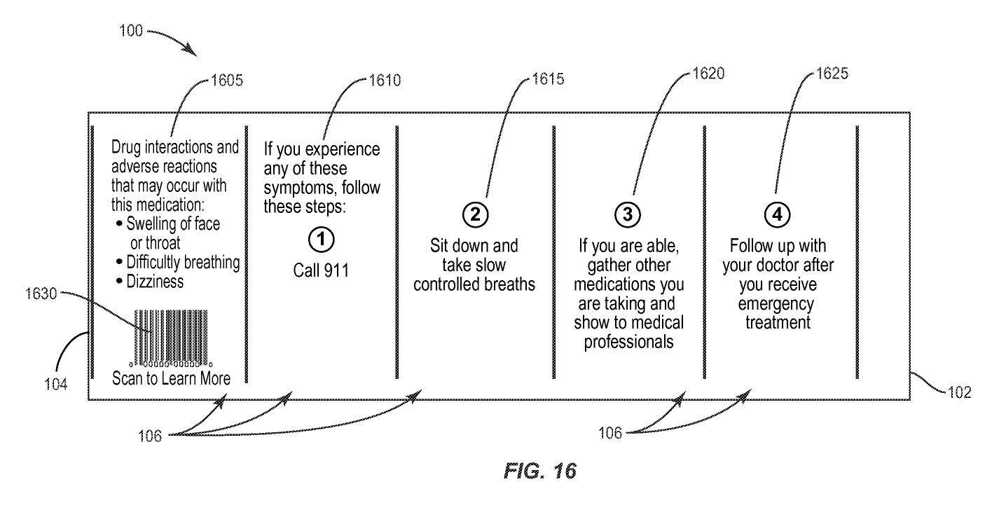

FIG. 16 illustrates various embodiments of a base label 100 with base label indicia 106 comprising a sequential set of instruction indicia 1605-1625 for actions which may be taken in the event of drug interaction. Referring to the label instruction delivery system such as that illustrated in FIGS. 15A through 15C, the top label 300 may be positioned such that instruction indicia 1605 is visible through the transparent window 1002, identifying possible symptoms that may result from a drug interaction or adverse reaction with the medication in the container 1405. By rotating the top label 300, the consumer may sequentially reveal additional instruction indicia 1610-1625 that may provide step-by-step instructions for actions to be taken after symptoms of a drug interaction or adverse reaction begin.

Various embodiments of the base label indicia 106 may comprise a machine readable indicia 1630. The consumer may use any electronic device, such as a smartphone, to read or scan the machine readable indicia 1630. The smartphone may comprise an application that enables a reading or scanning function on the smartphone. Once the smartphone (or other electronic device such as a tablet computer or scanner coupled to a computer) reads or scans the machine readable indicia 1630, the machine readable indicia 1630 may be configured to cause the smartphone to execute a function. In various embodiments, the function executed by the smartphone may be to open a web browser program and direct the browser to a pre-designated website.

As readily recognized by one skilled in the art, the function executed by the smartphone may be any function capable of being executed on an electronic computing device. For example, the function may be to display product information, or display a scannable coupon on the smartphone that the consumer may redeem at a store or online. The product information and the scannable coupon may be related to the product in the container 1405, or some other product or service. In various embodiments, the function may cause the smartphone to download an application onto the smartphone, or cause an application to run or execute an application, such as launching an interactive game on the smartphone. In various embodiments, the function executed may be to display medical information on the smartphone, such as a medical history of the consumer, potential drug interactions, overdose information, and the like. Where the product in the container 1405 is a food ingredient, the function executed may be to display one or more recipes on the smartphone that call for the food ingredient. In still other embodiments, the function executed may cause the smartphone to take a photograph of the machine readable indicia 1630. In some embodiments, the function executed may be to automatically register the consumer in a contest, or register the consumer to receive periodic updates about products or services.

The machine readable indicia 1630 may comprise any linear, 2-dimensional, or 3-dimensional indicia or code as known in the art that may be machine readable to cause an electronic device to execute a function when the machine readable indicia 1630 is scanned by the electronic device. For example, the machine readable indicia 1630 may comprise a High Capacity Color Barcode (HCCB) comprising a plurality of barcode shapes in combination with a plurality of colors per symbol. The machine readable indicia 1630 may comprise triangular shapes or circular shapes. According to various embodiments, the machine readable indicia 1630 may also comprise a Quick Response (QR) Code or a linear barcode.

In addition to the barcode illustrated in FIG. 16, other indicia, codes, or symbols, whether linear, 2-dimensional, 3-dimensional, color, or monochrome, as are known in the art may also be used for the machine readable indicia 1630 in various embodiments. For example, the machine readable indicia 1630 may comprise any or any combination of:
3-DI, a 2-dimensional matrix of circular symbols;
ArrayTag, a 2-dimensional matrix of groups of hexagonal symbols;
Aztec Code, a 2-dimensional square matrix of square symbols;
Codablock, a 2-dimensional array of stacked linear codes;
Code 1, a 2-dimensional matrix of horizontal and vertical bars;
Code 16K, a 2-dimensional array of stacked linear codes;
Code 49, a 2-dimensional array of stacked linear codes;
ColorCode, a 2-dimensional color matrix of square symbols;
CP Code, a 2-dimensional square matrix of square symbols;
DataGlyphs, a 2-dimensional matrix of “/” and “\” marks;
Data Matrix, a 2-dimensional square matrix of square symbols;
Datastrip Code, a 2-dimensional matrix of square symbols;
Dot Code A, a 2-dimensional square matrix of dots;
hueCode, a 2-dimensional matrix of blocks of cells in varying shades of gray;
MaxiCode, a 2-dimensional square matrix of interlocking hexagonal symbols;
MiniCode, a 2-dimensional square matrix of square symbols;
PDF 417, a 2-dimensional matrix of a combination of linear barcodes and square symbols;
Snowflake Code, a 2-dimensional square matrix of dots;
SuperCode, a 2-dimensional matrix of a combination of linear barcodes and square symbols;
Ultracode, a color or monochrome 2-dimensional array matrix of variable length strips of pixel columns; and
3D Barcode, an embossed linear barcode of lines of varying height.

The machine readable indicia 1630 described above represent a sampling of exemplary machine readable indicia currently available and are not to be construed as limiting in any manner. Other linear, 2-dimensional, and 3-dimensional codes, currently known or developed in the future, are within the scope of the present disclosure. Additionally, the base label indicia 106 may comprise any combination of machine readable indicia 1630, as well as non-machine readable indicia.

The top label 300 may comprise a dual ply (or multi-ply) construction in which a ply in contact with the base label 100 is a material selected for low sliding friction characteristics. The low sliding friction characteristics may enhance the ease of rotating and sliding the top label 300 about the base label 100. In various embodiments, the top label 300 ply in contact with the base label 100 may be coated with a substance to impart the low sliding friction characteristics.

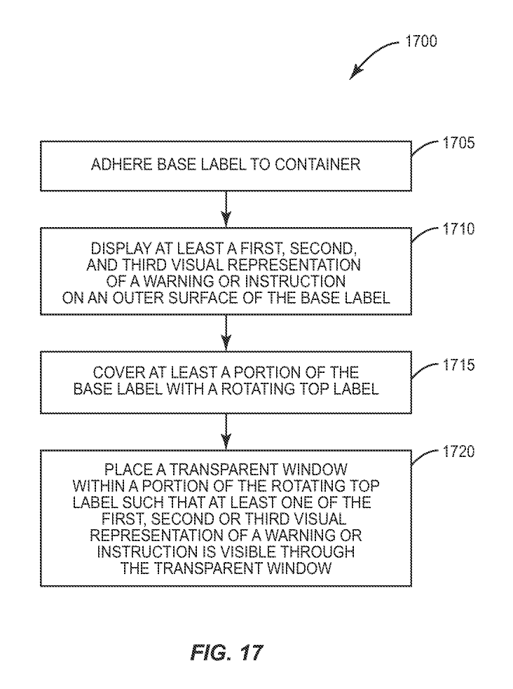

FIG. 17 illustrates a general flow chart of various embodiments of a method 1700 for delivering warnings and instructions associated with a container. A base label 100 may be applied to a container 1405 (step 1705). The base label 100 may have a back surface 206 and a front surface 108. At least a first, a second, and a third interaction or warning instruction indicia 1205-1225 may be displayed on the front surface 108 of the base label 100 (step 1710). At step 1715, at least a portion of the base label 100 may be covered with a rotating top label 300. In various embodiments, the base label 100 may be coupled to the container 1405 while the top label 300 is free to rotate about the base label 100. A transparent window 1002 may be placed within a portion of the rotating top label 300 at step 1720 such that at least one of the first, second, or third instruction indicia 1205-1225 is visible through the transparent window 1002. As the top label 100 is rotated about the base label 100, the first, second, and third instruction indicia 1205-1225 may alternately be visible through the transparent window 1002. In various embodiments, more than one of the instruction indicia 1205-1225 may be visible through the transparent window 1002. In various embodiments, the top label 300 may comprise multiple transparent windows 1002 such that multiple instruction indicia 1205-1225 may be visible simultaneously through the multiple windows 1002.

In various embodiments, the instruction indicia 1205-1225 may be imprinted, embossed, or molded directly on an outer surface of the container 1405 in place of all or a portion of the base label 100. The imprinting or embossing may be carried out using any printing or image transfer method known in the art. In various embodiments, the printing or image transfer method may be an offset process in which an image is transferred from a plate to an intermediate carrier, then to the outer surface of the container 1405. The offset process may also involve lithographic techniques. Other printing or image transfer methods may comprise, for example, flexography, pad printing, relief printing, rotogravure, screen printing, and electrophotography. According to various embodiments, the instruction indicia 1205-1225 may be digitally printed on the outer surface of the container 1405 using, for example, inkjet printing or laser printing. Chemical printing technologies, such as blueprint or diazo print may also be used in various embodiments.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A rotating label warning and instruction delivery system for a container, the system comprising:
a base label adhered to the container, the base label having a back surface and a front surface;
at least a first, a second, and a third visual representation of a warning or instruction on the front surface of the base label;
an opaque rotating top label covering at least a portion of the front surface of the base label; and
a transparent window within a portion of the opaque rotating top label, the transparent window allowing at least one of the first, second, or third visual representations to be visible through the transparent window.

2. The system of claim 1, wherein the transparent window allows at least two of the first, second, or third visual representations to be visible through the transparent window.

3. The system of claim 1, wherein the top label rotates over the base label.

4. The system of claim 1, wherein the visual representations comprise graphical images.

5. The system of claim 4, wherein the graphical image represents the warning or instruction.

6. The system of claim 1, wherein the visual representations comprise pictograms.

7. The system of claim 6, wherein the pictogram represents the warning or instruction.

8. The system of claim 1, further comprising one or more words or phrases displayed with the visual representation.

9. The system of claim 1, wherein the visual representations further comprise a machine readable indicia.

10. The system of claim 9, wherein the machine readable indicia is a bar code.

11. The system of claim 9, wherein the machine readable indicia is a quick response code.

12. The system of claim 1, wherein the visual representations comprises a sequential series of instructions.

13. A rotating label warning and instruction delivery system for a container, the system comprising:
a plurality of pictograms on a surface of the container, the pictograms representing a warning or instruction; and
a rotatable label covering at least a portion of the plurality of pictograms and displaying at least one of the plurality of pictograms.

14. The system of claim 13, further comprising a base label coupled to the surface of the container, wherein the plurality of pictograms is printed on the base label.

15. The system of claim 13, wherein the rotatable label covers at least a portion of the base label.

16. The system of claim 13, wherein the rotatable label comprises a transparent window within a portion of the rotating label, the transparent window allowing at least one of the plurality of pictograms to be visible through the transparent window.

17. A method for delivering warnings and instructions associated with a container, the method comprising:
adhering a base label to the container, the base label having a back surface and a front surface;
displaying at least a first, a second, and a third visual representation of a warning or instruction on the front surface of the base label;
covering at least a portion of the front surface of the base label with a rotating top label; and
placing a transparent window within a portion of the rotating top label, the transparent window allowing at least one of the first, second, or third visual representations to be visible through the transparent window.

18. The method of claim 17, wherein the transparent window allows at least two of the first, second, or third visual representations to be visible through the transparent window.

19. The method of claim 17, wherein the top label rotates over the base label.

20. The method of claim 17, wherein the visual representations comprise graphical images.

21. The method of claim 20, wherein the graphical images represent the warning or instruction.

22. The method of claim 17, wherein the visual representations comprise pictograms.

23. The method of claim 22, wherein the pictograms represent the warning or instruction.

24. The method of claim 17, further comprising one or more words or phrases displayed with the visual representations.

25. The method of claim 17, wherein the visual representations comprise a sequential series of instructions.
